(19) United States
(12) Patent Application Publication
(10) Pub. No.: US 2013/0325634 A1
(43) Pub. Date: Dec. 5, 2013

(54) METHOD FOR PROVIDING SERVICE THAT USES A CONSUMER'S PURCHASED PRODUCT AS ADVERTISEMENT MEDIA THROUGH DIGITAL CODE TO ALLOW EXPOSERS AND RECOGNIZERS OF DIGITAL CODE TO ACHIEVE PROFIT OF ADVERTISEMENT

(71) Applicants: Jong-Moon YANG, Seoul (KR); Hoon KANG, Seoul (KR)

(72) Inventors: Jong-Moon YANG, Seoul (KR); Hoon KANG, Seoul (KR)

(73) Assignee: Artarch & Door Works Inc., Seoul (KR)

(21) Appl. No.: 13/486,796

(22) Filed: Jun. 1, 2012

(51) Int. Cl. G06Q 30/02

(52) U.S. Cl. 705/14.69

(57) ABSTRACT

A method for providing a service uses a consumer's used product as advertisement media through a digital code allowing exposers and recognizers of the digital code to achieve profit from advertisement. When a Web server selling an article receives a purchase request for the article having a predetermined digital code, the Web server compensates the purchaser and/or a third person, and receives a compensated amount from an advertiser as a terminal used by the purchaser/third person recognizes the digital code added to the article and notifies the Web server. As the purchaser selects the digital code to be carved on the article, the purchaser makes an advertisement instead of the advertiser, and receives in return a reduction in the purchase price and compensation. The Web server can lower the price of the article in return for selling the article with the digital code, or benefit the purchaser through compensation.

### BACKGROUND

(a) Technical Field

The present invention relates to a method for providing a service that uses a consumer's used product as advertisement media through a digital code to allow exposers and recognizers of the digital code to achieve a profit of advertisement.

(b) Background Art

Digital codes are being used as a means for implicitly containing information on articles or volume of information such as other expressions. A QR code is provided as one example of the digital code. Since the QR code can store significantly much more information than for example, a system such as an existing barcode, the QR code is used to store information on the administration of physical distribution or other products or information regarding a seller with the QR code attached or printed onto a variety of articles. Further, in order to utilize an advantage that the QR code can store the volume of information, a QR code generator program is also commercialized, through which a general user can personally make QR code containing a desired expression.

Furthermore, enterprises themselves are manufacturing a product into which the QR code is inserted into a part. In this case, the QR code serves to allow a user to acquire article-associated information or publicize the enterprises through the QR code by storing information on articles manufactured by the enterprises or logos or advertisement expressions of the enterprises or Website addresses of the enterprises.

However, since a current QR code is used for a limited purpose such as simply storing information on a product or storing information depending on a personal taste or advertising the enterprise, it is disadvantageous that a use effect is insignificant as a purpose of providing an article or a service and advertising the seller himself/herself or publicizing the product by using the QR code. This is based on reality that the QR code is used only for a passive purpose such as connecting the Website stored in the QR code by recognizing the QR code through a terminal such as a smart phone when the user intends to acquire product-associated information.

Accordingly, a way to grant a motive capable of more actively using the QR code to the user so as to actively use the QR code in marketing from an enterprise's standpoint is requested and a scheme for a general user to make a compensation depending on an action of recognizing information stored in the QR code is required.

### SUMMARY OF THE DISCLOSURE

The present invention has been made in an effort to provide a method that can utilize a digital code such as a QR code in marketing such as advertising an enterprise's own brand through the digital code from an enterprise's standpoint and grant a motive for a general user to more actively use the digital code to be profitable to both the enterprise and the user.

An embodiment of the present invention provides a method for providing a service that uses a consumer's used product as advertisement media through a digital code to allow exposers and recognizers of the digital code to achieve a profit of advertisement, including: a) receiving, a Web server selling an article, a purchase request for the article added with a predetermined digital code from a purchaser terminal used by a purchaser; and b) paying, the Web server or an advertiser server requesting for adding the digital code, a return to the purchaser as a terminal used by a third person recognizes the digital code added to the article and transmits the recognition fact to the Web server.

The method may further include the Web server's receiving the return for the compensation given to the purchaser, from the advertiser server.

The level of the compensation made by the Web server in step b) may be equivalent to the number of times that the terminal recognizes and transmits the digital code. When the recognition and transmission of the digital code from the same transmitter or the same terminal are duplicately made with respect to article or the same digital code, the Web server may exclude the duplicated digital code from reflection of the compensation level.

The Web server may transmit a predetermined advertisement content to the terminal that recognizes and transmits the digital code. In this case, the Web server may make a reduction or compensation when a fact that a user of the terminal receiving the advertisement content verifies the advertisement content from the terminal is transmitted to the Web server.

Meanwhile, unique information for identifying the purchaser may be included in the digital code provided by the Web server in step a).

### BRIEF DESCRIPTION OF THE DRAWINGS

The above and other features of the present invention will now be described in detail with reference to certain embodiments thereof illustrated the accompanying drawings which are given hereinbelow by way of illustration only, and thus are not limitative of the present invention, and wherein:

FIG. 1 is a diagram illustrating a system for providing an article purchase compensation service and an advertisement agent service and a process thereof according to the present invention.

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below.

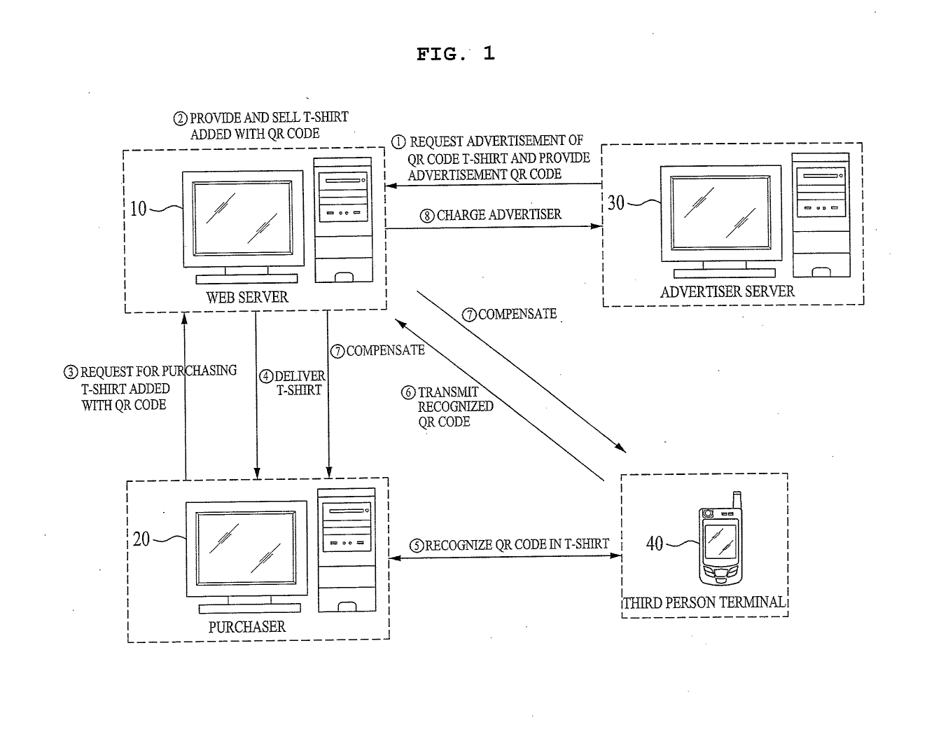

FIG. 1 is a diagram illustrating a system for providing an article purchase compensation service and an advertisement agent service and a process thereof through a digital code according to the present invention. In the embodiment, a QR code will be exemplified as one example of the digital code. However, the present invention is not limited to the QR code and includes all kinds of codes which can be recognized and imaged using a scanner or a camera as a bar code or new other codes.

An entire system required to implement the present invention includes a Web server 10, a purchaser terminal 20, an advertiser server 30, and a third-person terminal 40. They are connected to each other through a wired or wireless communication network to make data communication with each other and for ease of illustration, the Internet or the wireless communication network is not illustrated.

The Web server 10 as a server that sells the article and for example, an example of the Web server 10 corresponds to a server that operates a shopping mall on the Web. In the embodiment, as one example of the article sold by the Web server 10, a T-shirt is exemplified.

The purchaser terminal 20 as a terminal to be used by a purchaser who intends to purchase the article is to make a purchase request to the Web server 10 by accessing the Web server 10. The purchaser terminal 20 may be an apparatus such as a smart phone as well as a general computer.

The advertiser server 30 as a server of an advertiser who intends to make an advertisement through the QR code is to directly produce the QR code and provide the QR code to the Web server 10 or request for producing the QR code to the Web server 10 in order for the advertiser to advertise his/her own brand or article or notify his/her Website through the Web server 10. In the present invention, the advertiser is a principal agent that intends to advertise articles manufactured by other persons through the QR code and therefore, a principal agent that manufactures or sells the article sold by the Web server 10 is a principal agent that is different from the advertiser. That is, the Web server 10 is a server in which an administrator of the Web server 10 directly sells articles manufactured by himself/herself or which provides a store for articles manufactured by other persons, such as an open market. The article which the advertiser intends to advertise does not correspond to the article which the Web server 10 intends to manufacture or sell.

The third person terminal 40 as a terminal possessed by a third person other than the purchaser is to recognize the QR code and receive a predetermined return from the Web server 10 by transmitting the recognized QR code to the Web server 10. The third person terminal 40 as a terminal installed with a program that allows the user to extract or convert information in the QR code in a recognizable type by recognizing the QR code may be a terminal such as the general computer or the smart phone.

Hereinafter, a process of the method for providing an article purchase compensation service and an advertisement agent service through the QR code according to the present, which is implemented by the system, will be described for each step illustrated in FIG. 1.

First Step

The advertiser server 30 requests for making an advertisement of adding the QR code to the T-shirt sold by the Web server 10 to the Web server 10. The T-shirt sold by the Web server 10 may be an advertiser's own product and an article manufactured by the Web server 10 itself or supplied from other enterprises. When the advertiser server 30 requests the advertisement through the QR code, the QR code may be produced by the advertiser server 30 itself to be provided to the Web server 10 and the Web server 10 may produce the QR code. However, the advertiser generally produces a content such as his/her brand, his/her Website address, or an advertisement copy with respect to a content which the advertiser himself/herself intends to advertise, and when the advertiser server 10 provides the QR code produced based on the content to the Web server 10 or the advertiser server 10 provides the content to the Web server 10, the Web server 10 will produce the QR code corresponding thereto.

Second Step

The Web server 10 produces/sells the T-shirt to which the QR code requested from the advertiser server 30 is added. The process of adding the QR code to the T-shirt may be performed by the administrator of the Web server 10 or performed according to a request from the administrator of the Web server 10 by the T-shirt producer. The Web server 10 displays the T-shirt onto the Website administrated by the Web server 10 to receive a purchase request from a general purchaser.

Third Step

The purchaser of the article makes a purchase request for the T-shirt added with the QR code to the Web server 10 by using the purchaser terminal 20. In this case, the purchaser may preferably select whether the purchaser will purchase the T-shirt attached with the QR code or whether the purchaser will purchase a T-shirt not attached with the QR code at the time of purchasing the T-shirt. When the QR code is provided from plural advertiser servers 30 as plural advertisers are present, the user may select the QR code provided by the advertiser most suitable (for example, confers most profits) to the user himself/herself and the Web server 10 presents the respective QR codes provided by the plural advertisers to the purchaser to allow the purchaser to select the QR code.

Fourth Step

When the purchaser pays the amount depending on purchasing of the T-shirt through the purchaser terminal 20, the administrator of the Web server 10 delivers the purchased T-shirt to the purchaser. As the purchaser wears the delivered T-shirt, the QR code carved on the T-shirt is naturally exposed to other persons.

Fifth Step

The third person other than the purchaser recognizes the QR code which the purchaser wears and images the QR code carved on the T-shirt through his/her own terminal 40. The purchaser terminal 40 is the apparatus such as the smart phone in which a QR code recognition program is installed. Therefore, as the QR code is imaged by the purchaser terminal 40, information contained in the QR code is converted into a pattern which the third person can recognize. Accordingly, the third person recognizes through his/her own terminal 40 information such as an advertisement expression or a brand name which the advertiser inserts into the QR code so that an advertisement of the advertiser for the third person is made.

Sixth Step

The third person transmits the recognized QR code to the Web server 10 by operating his/her own terminal 40. In this case, the QR code itself may be transmitted to the Web server 10, the QR code maybe the information converted into the pattern which the QR code can be recognized or the QR code may be a notification regarding a fact that the QR code is recognized. By this configuration, the Web server 10 may see that the third person recognizes the QR code.

Seventh Step

When the Web server 10 receives the notification associated with the recognition of the QR code from the third person terminal 40, the Web server 10 makes a predetermined compensation for a purchaser using the purchaser terminal 20 and/or a user of the third person terminal 40 according to an advanced contract with the advertiser. The compensation may be achieved in various ways of providing cash, points, and other articles or services.

Eighth Step

The Web server 10 requests to the advertiser server 30 the amount of money or a return for compensation provided to the user of the purchaser terminal 20 and the user of the third terminal as advertisement cost. The advertiser which is the administrator of the advertiser server 30 provides the requested amount of money to the Web server 10 to settle the advertisement cost.

According to the present invention, as the purchaser selects the QR code to be carved on the article purchased by the purchaser himself/herself, the purchaser may make an advertisement instead of the advertiser and receive the reduction of an article purchase price or a compensation in return

Further, the Web server 10 may reduce the cost of the purchased article to the user in return for purchasing the article with the carved QR code or confer a benefit on the purchaser through the compensation so that competitiveness as the seller may be increased as compared with other shopping malls. Further, even though sale competitiveness is increased, a monetary loss is never caused, but an additional income may be increased through advertisement cost received from the advertiser.

Further, from the viewpoint of the advertiser, since only when the purchaser or the third person recognizes the QR code and directly faces an advertising copy therethrough, and the advertiser pays the advertisement cost corresponding thereto, it is advantageous that as compared with a general advertising pattern exposed to unspecified persons, only when the exposure for the advertisement exists, the advertisement cost is paid and as a result, a so called target advertisement is possible.

Meanwhile, the method of providing the article purchase compensation service and the advertisement agent service through the QR code according to the embodiment of the present invention may be modified in various methods as follows.

The third step may be modified in a way in which when the purchase request for the T-shirt added with the QR code is received from the purchaser terminal 20, the Web server 10 reduces or compensates the purchase price of the T-shirt by a predetermined sum contracted with the advertiser in advance. As described above, the purchaser settles the reduced sum (alternately, the sum to which the compensation is reflected) and thereafter, operation of the purchaser for the purchase is completed. The reduction may be performed by various methods such as a method of reducing 10% of the purchase price of the T-shirt, a method of accumulating points corresponding to 10% of the purchase price, a method of providing use authority of other articles or services, or the like.

Further, in the aforementioned embodiment, the compensation for the purchaser is described as the compensation for exposing the QR code to others, but the compensation may be provided as the price for purchasing the article carved with the QR code at the time of purchasing the article unlike this or in addition to this. In this case, the compensation may also be preformed in a way such as the reduction of the article price, the accumulation of the point, free provision of other services or accessory articles, and the like.

Meanwhile, only with the purpose of increasing the sum for which the third person or the purchaser is compensated, the case of intentionally transmitting the QR code carved on the same article many times may occur. Accordingly, in the case where the QR code is recognized and transmitted from the same transmitter or the same terminal with respect to the same article or the same QR code at the same time, the Web server 10 may not provide an additional compensation. Accordingly, in this case, the Web server 10 excludes the reduction, the compensation price, or the point from the reflection of the calculation thereof.

Further, in order to more improve an advertising effect of the advertiser, at the sixth step, in the case where whether or not the QR code is recognized from the third person terminal 40 is transmitted to the Web server 10, the Web server 10 may be configured to transmit predetermined advertisement contents to the terminal 40 which recognizes and transmits the QR code. Accordingly, the advertiser may acquire an additional advertising effect. Furthermore, in this case, the fact that the user verifies the advertisement contents from the terminal 40 that receives the advertisement contents is transmitted to the Web server 10 and only when the transmission is made, the Web server 10 may make the reduction or compensation or make an additional reduction or compensation. As a result, the advertisement effect by the additional advertisement contents is more enhanced.

Meanwhile, it is preferable that unique information for identifying the purchaser is included in the QR code provided by the Web server 10. That is, the unique information is added to the QR code so as to identify who is a purchaser of the same article in addition to the advertisement expression requested by the advertiser. The unique information of the purchaser may be for example, an ID of the purchaser. Further, for example, since there may be a case where any purchaser purchases various kinds of QR codes (that is, the QR codes of the plural advertisers) simultaneously or with a difference in time, the unique information may be reflected to the QR code by generating an additional serial number corresponding to the ID of the purchaser in order to easily identify the purchaser for each QR code and adding the generated serial number to the QR code in that case. By this configuration, in the sixth step, it can be known who the purchaser is through the unique information in the QR code transmitted from the third person terminal 40, and as a result, compensation for the purchaser exposed to the advertisement may be accurately made.

Meanwhile, in the embodiment of FIG. 1, the compensation for the purchaser or the third person is performed by the Web server 10, but the compensation may be modified to be performed by the advertiser server 30. That is, unlike the example of FIG. 1, the compensation in the seventh step may be made directly by the advertiser server 30. In this case, in the eighth step of FIG. 1, the Web server 10 need not receive the compensation money from the advertiser server 30.

Furthermore, the compensation for the purchaser is made by the Web server 10 and the compensation for the third person is made by the advertiser server 30 or the compensation may be made on the contrary to this.

According to the present invention, as a purchaser selects a digital code to be carved on an article purchased by the purchaser himself/herself, the purchaser makes an advertisement instead of an advertiser and receives the reduction of an article purchase price and a compensation in return. A Web server can lower a price for a purchased article for a user in return for selling an article carved with the digital code or confer a benefit to the purchaser through compensation. Since an advertiser pays a corresponding advertisement cost only when the purchaser or a third person recognizes the digital code and directly faces an advertisement expression through the digital code, it is advantageous that the advertisement cost is paid only in advertisement exposure.

While the invention will be described in conjunction with embodiments, it will be understood that present description is not intended to limit the invention to those embodiments. On the contrary, the invention is intended to cover not only the embodiments, but also various alternatives, modifications, equivalents and other embodiments, which may be included within the spirit and scope of the invention as defined by the appended claims.

What is claimed is:

1. A method for providing a service that uses a consumer's used product as advertisement media through a digital code to allow exposers and recognizers of the digital code to achieve a profit of advertisement, comprising:
a) receiving, a Web server selling an article, a purchase request for the article added with a predetermined digital code from a purchaser terminal used by a purchaser; and
b) paying, the Web server or an advertiser server requesting for adding the digital code, a return to the purchaser as a terminal used by a third person recognizes the digital code added to the article and transmits the recognition fact to the Web server.

2. The method for providing a service that uses a consumer's used product as advertisement media through a digital code to allow exposers and recognizers of the digital code to achieve a profit of advertisement of claim 1, further comprising receiving, the Web server, the return for the compensation given to the purchaser, from the advertiser server.

3. The method for providing a service that uses a consumer's used product as advertisement media through a digital code to allow exposers and recognizers of the digital code to achieve a profit of advertisement of claim 1, wherein the level of the compensation made by the Web server in step b) is equivalent to the numbers of times that the terminal recongizes and transmits the digital code.

4. The method for providing a service that uses a consumer's used product as advertisement media through a digital code to allow exposers and recognizers of the digital code to achieve a profit of advertisement of claim 3, wherein when the recognition and transmission of the digital code from the same transmitter or the same terminal are duplicately made with respect to article or the same digital code, the Web server excludes the duplicated digital code from reflection of the compensation level.

5. The method for providing a service that uses a consumer's used product as advertisement media through a digital code to allow exposers and recognizers of the digital code to achieve a profit of advertisement of claim 1, further comprising transmitting, the Web server, a predetermined advertisement content to the terminal that recognizes and transmits the digital code.

6. The method for providing a service that uses a consumer's used product as advertisement media through a digital code to allow exposers and recognizers of the digital code to achieve a profit of advertisement of claim 5, wherein the Web server makes a reduction or compensation when a fact that a user of the terminal receiving the advertisement content verifies the advertisement content from the terminal is transmitted to the Web server.

7. The method for providing a service that uses a consumer's used product as advertisement media through a digital code to allow exposers and recognizers of the digital code to achieve a profit of advertisement of claim 1, wherein unique information for identifying the purchaser is included in the digital code provided by the Web server in step a).
